(19) United States
(12) Patent Application Publication
(10) Pub. No.: US 2026/0207308 A1
(43) Pub. Date: Jul. 23, 2026

(54) DENTAL IMPLANT SYSTEM

(71) Applicant: INNODEN CO., LTD., Siheung-si (KR)

(72) Inventor: Cheon Seok JANG, Ansan-si (KR)

(21) Appl. No.: 19/447,922

(22) Filed: Jan. 13, 2026

(30) Foreign Application Priority Data
Jan. 17, 2025 (KR) 10-2025-0007060

(51) Int. Cl. A61C 8/00

(52) U.S. Cl. CPC A61C 8/0057; A61C 8/0059; A61C 8/0063

(57) ABSTRACT

The present disclosure relates to a dental implant system, and more particularly, to a design for preventing a sealing member installed between a crown (artificial tooth) and an abutment from protruding (being extruded) during a process in which the sealing member is pushed outward by applied pressure. More particularly, the present disclosure relates to a dental implant system that prevents protrusion of a sealing member by forming a space between the crown and the abutment that can accommodate a portion of the sealing member that is pushed outward and protrudes into an oral cavity.

### CROSS-REFERENCE TO RELATED APPLICATIONS

This application claims the priority of Korean Patent Application No. 10-2025-0007060 filed on Jan. 17, 2025, in the Korean Intellectual Property Office, the disclosure of which is incorporated herein by reference.

### BACKGROUND

### Field

The present disclosure relates to a dental implant system, and more particularly, to a design for preventing a sealing member installed between a crown (artificial tooth) and an abutment from protruding (being extruded) during a process in which the sealing member is pushed outward by applied pressure (force). More particularly, the present disclosure relates to a dental implant system that prevents protrusion of a sealing member by forming a space between the crown and the abutment that can accommodate a portion of the sealing member that is pushed outward and protrudes into an oral cavity.

### Description of the Related Art

When a crown and an abutment in a dental implant system are joined without an adhesive, there is a risk that foreign substances in an oral cavity penetrate a minute gap between the two parts. Such penetration of foreign substances adversely affects oral hygiene and may cause problems in the long-term stability and functionality of an implant system. Accordingly, a member (hereinafter referred to as a “sealing member”) is employed to seal(close) the gap between the crown and the abutment.

Conventional sealing members have a property of self-contraction when pressure is applied. However, depending on material characteristics, when pressure exceeding a certain level is applied, an extrusion phenomenon may occur in which the sealing member is pushed and protrudes toward a side to which less force is applied. In particular, when the sealing member is pushed outward between the abutment and the crown and protrudes into the oral cavity, this not only deteriorates aesthetics but also may cause functional and hygienic problems due to interaction of the protruded sealing member with the oral environment.

### SUMMARY

Accordingly, the present disclosure is proposed to solve various problems that may occur in a dental implant system in which a sealing member is applied between a crown and an abutment.

An object of the present disclosure is to provide a dental implant system that can secure aesthetics, hygiene, and stability by preventing a sealing member installed between a crown and an abutment from protruding into the oral cavity during the process of being pushed outward by the applied pressure.

In addition, another object of the present disclosure is to provide a dental implant system in which the sealing member is stably fixed so that the sealing member does not come out to the outside due to occlusal force even when the sealing member is not firmly attached to the inside of the crown.

In addition, objects of the present disclosure are not limited to the objects, and various objects may be additionally provided through the techniques described in the embodiments and claims described below.

In order to achieve the above-described objects, the present disclosure provides a dental implant system in which a sealing member is installed between a crown and an abutment, in which a plurality of grooves is formed on each of an outer surface of a post of the abutment and an upper surface of a cuff.

Moreover, the plurality of grooves may be connected continuously.

In addition, the sealing member may be installed to cover the plurality of grooves.

Moreover, a plurality of grooves may be formed in each of an inner accommodating groove and a lower portion of the crown.

Furthermore, the plurality of grooves formed in the crown may be connected continuously.

Moreover, the plurality of grooves formed in the crown may be formed to face the plurality of grooves formed in the abutment.

Also, the sealing member may be formed of a laminated structure in which a plurality of circular rings, donut-shaped springs, or “C” shaped rings with one side open are laminated, or may be formed in a hat shape.

Additionally, the sealing member may be formed in the form of a cone.

Moreover, the dental implant system may further include a fixing member for fastening and fixing the crown to the abutment.

Additionally, the sealing member may be made of an elastic body having elasticity.

In addition, the elastic body may be made of any one selected from a silicone material, a synthetic rubber material, a metal material in the form of an elastic fabric, or a synthetic resin material.

Additionally, each of the plurality of grooves may have a semicircular, semi-elliptical, or “V” or “U”-shaped structure.

As described above, according to embodiments of the present disclosure, the following effects can be obtained.

First, when pressure is applied to the sealing member, a portion of the sealing member can be prevented from protruding into the oral cavity. This prevents the sealing member installed between the crown and the abutment from protruding into the oral cavity during the process of being pushed outward by the applied pressure, thereby ensuring aesthetics, hygiene, and stability.

Second, occlusal force can be stably distributed. Since an elastic sealing member is positioned between the abutment and crown, when the occlusal force is applied to the crown during masticatory movement, the force is distributed, preventing fracture of the crown, abutment, fixture, and screw.

Third, the crown can be securely fixed to the abutment without the use of adhesive. By positioning the sealing member between the abutment and the crown, fracture of the crown can be prevented even when joining the crown to the abutment with a fixing member without using adhesive.

Fourth, stable installation of the ring-shaped sealing member is possible. In a case where the sealing member has a structure in which ring-shaped portions are continuously connected, when the sealing member is attached and set on an inner side of the crown, the ring-shaped sealing member is likely to naturally settle in a curved portion of the abutment. This allows the ring-shaped sealing member to be latched onto the curved accommodating groove, providing a stable fixation effect.

Fourth, it is possible to improve aesthetics. Even when using a relatively thick sealing member, the groove of the abutment and/or crown accommodates a portion of the sealing member, making the sealing member appear thinner when viewed from the outside, thereby improving the aesthetics of the implant.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIGS. 1A and 1B are cross-sectional views illustrating a state where a sealing member is installed on an abutment.

FIGS. 2A and 2B are cross-sectional views illustrating a state where a portion of the sealing member is pushed outward and protrudes.

FIG. 3 is a cross-sectional view illustrating an abutment according to one embodiment of the present disclosure.

FIG. 4 is a cross-sectional view illustrating a crown according to one embodiment of the present disclosure.

FIG. 5 is a cross-sectional view illustrating a dental implant system according to one embodiment of the present disclosure.

FIGS. 6A to 6D are views illustrating a sealing member according to one embodiment of the present disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Hereinafter, the advantages and features of the present disclosure and the methods for achieving them will be clarified with reference to the embodiments described in detail below together with the accompanying drawings. In addition, the same reference numerals refer to the same components throughout this specification. In addition, each component illustrated in each drawing may be excessively illustrated in size and shape, but this is for the convenience of explanation and is not intended to be limiting. In addition, when it is described as “A and/or B”, it can mean both A and B, or either A or B.

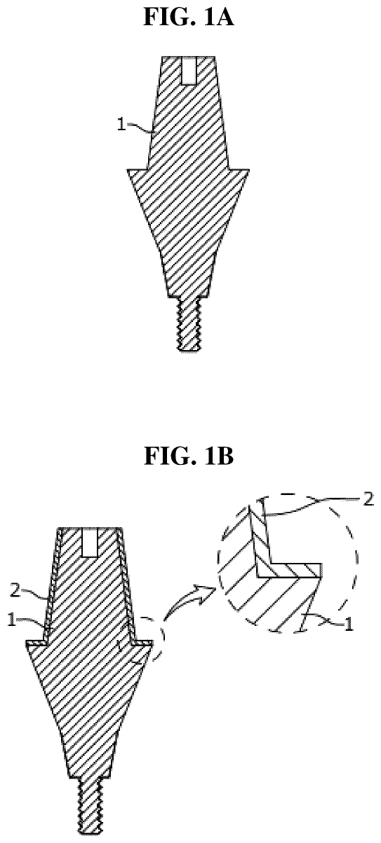

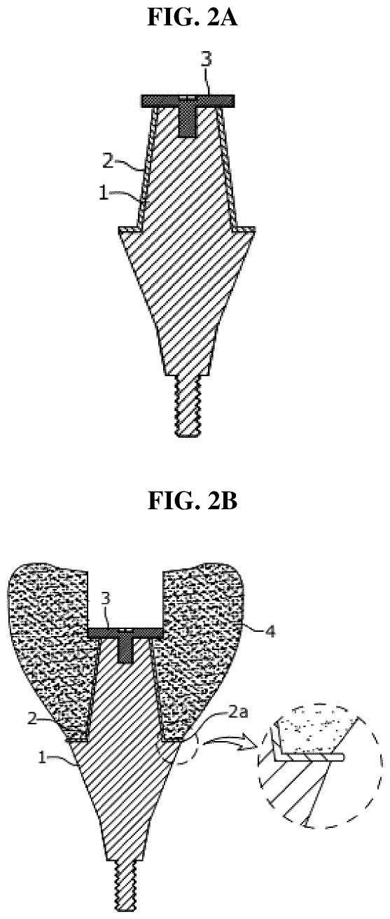

FIGS. 1A and 2B are schematic views for explaining a dental implant system to which a sealing member is applied. FIGS. 1A and 1B are cross-sectional views illustrating a state where a sealing member is installed on an abutment and FIGS. 2A and 2B are cross-sectional views illustrating a state where a portion of the sealing member protrudes outward.

Referring to FIGS. 1A and 2B, the dental implant system includes a sealing member 2 installed between an abutment 1 and a crown 4. The crown 4 is fixedly joined to the abutment 1 via a fixing member 3. When pressure is applied to the sealing member 2, the sealing member contracts only up to a certain extent depending on the material of the sealing member, and is pushed toward a side to which no pressure is applied and protrudes (refer to FIG. 2B). In particular, when the sealing member 2 is pushed outward between the abutment 1 and the crown 4 and protrudes into the oral cavity, this not only deteriorates aesthetics but also may irritate the gingiva, cause a foreign body sensation, and allow foreign substances to adhere thereto, thereby causing hygienic problems.

Accordingly, in a dental implant system according to one embodiment of the present disclosure, when pressure is applied to a sealing member, a space is formed within the sealing member to accommodate the protruding portion, taking into account the portion that is pushed out and protrudes. This prevents the sealing member from protruding into the oral cavity. The space accommodating the protruding portion may be formed in the abutment and/or crown.

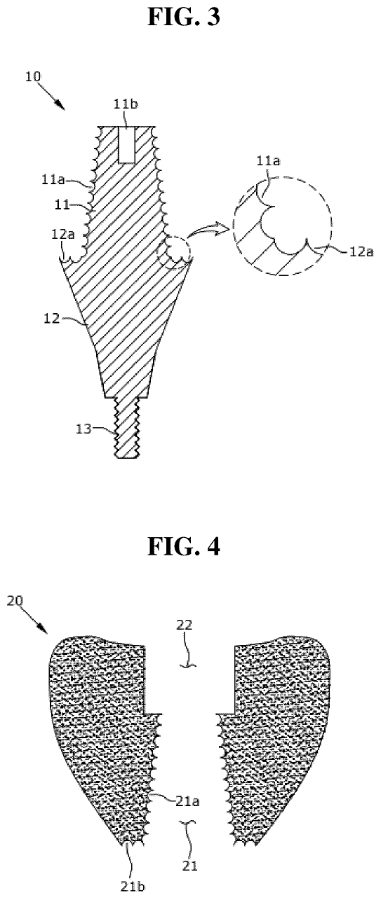

FIG. 3 is a view schematically illustrating a cross-section of an abutment according to one embodiment of the present disclosure, and is a view illustrating a cross-section of an abutment in which a screw is integrally formed, as an example.

Referring to FIG. 3, an abutment 10 according to one embodiment of the present disclosure includes a post 11 and a cuff 12. A screw 13 that is screw-connected to a fixture (not illustrated) implanted into an alveolar bone may be integrally formed at the lower portion of the cuff 12. In the case of an abutment having a structure in which the screw is separated, a separate screw member inserted into the center of the abutment is used.

A plurality of grooves 11a and 12a is formed on each of the outer surface of the post 11 and the upper surface of the cuff 12.

As illustrated in FIG. 3, the groove 11a may be formed as a curved accommodating groove structure in which a plurality of grooves is connected continuously from the lower end to the upper end of the post 11. The groove 11a may be formed as a semicircular or semi-elliptical structure, or as a “V”-shaped groove or a “U”-shaped groove structure.

The groove 12a may also be formed as a curved accommodating groove structure in which a plurality of grooves is connected continuously from the lower end of the post 11 to the outer end of the cuff 12. This groove 12a may be formed as a semicircular or semi-elliptical structure, or as a “V”-shaped groove or a “U”-shaped groove structure.

FIG. 4 is a cross-sectional view schematically illustrating a crown according to one embodiment of the present disclosure.

Referring to FIG. 4, a crown 20 according to one embodiment of the present disclosure has grooves 21a formed on the inner surface of an inner accommodating groove 21 in which the post 11 of the abutment 10 is accommodated, and also has grooves 21b formed on the lower portion covering the upper surface of a cuff 12. The grooves 21a and 21b may be formed in a plurality of grooves to be connected continuously, similar to the grooves 11a and 12a formed in the abutment 10.

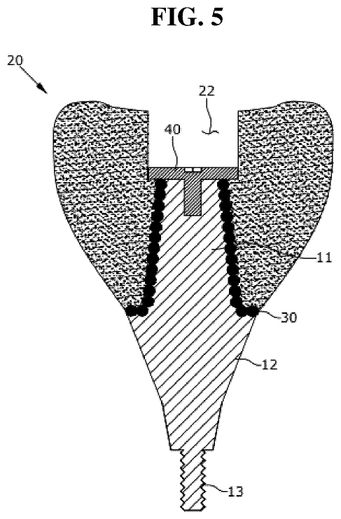

FIG. 5 is a cross-sectional view schematically illustrating a dental implant system according to one embodiment of the present disclosure.

Referring to FIG. 5, the dental implant system according to one embodiment of the present disclosure includes a sealing member 30 installed between the abutment 10 and the crown 20 so as to cover grooves 11a formed on the outer surface of the post 11 of the abutment 10 and grooves 12a formed on the upper surface of the cuff 12.

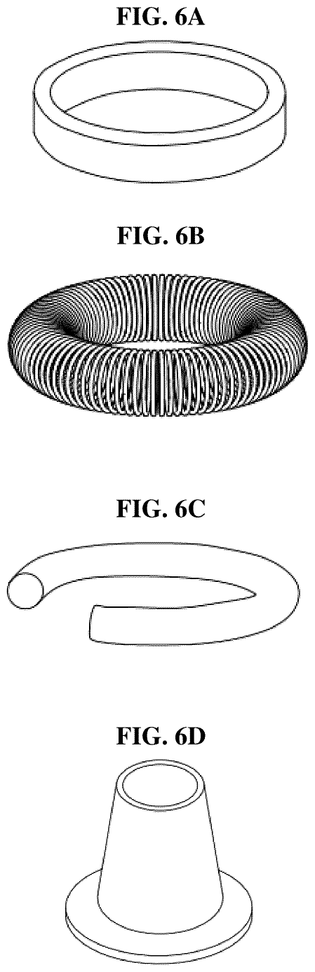

FIGS. 6A to 6D are views schematically illustrating a sealing member according to one embodiment of the present disclosure.

Referring to FIGS. 5 and 6, the sealing member 30 according to one embodiment of the present disclosure may be formed as a laminated structure in which a plurality of circular rings (corresponding to the number of grooves 11a and 12a) (refer to FIG. 6A), donut-shaped springs (refer to FIG. 6B), or “C” shaped rings with one side open (refer to FIG. 6C) are sequentially laminated, or may be formed in a hat shape (refer to FIG. 6D).

This sealing member 30 may be formed of an elastic body having elasticity. For example, the sealing member 30 may be formed of any one selected from a silicone material, a synthetic rubber material such as fluoroelastomer, a metal material in the form of an elastic fabric, or a synthetic resin material. The metal material in the form of an elastic fabric may be a woven material (for example, a mesh) made by tightly weaving nitinol wire.

The sealing member 30 may be configured to have a structure in which the diameter decreases toward the top in accordance with the shape of the post 11. For example, the sealing member 30 may be configured to have a truncated cone-shaped structure with an open top so that the screw portion of the fixing member 40 is inserted through and fastened to the fastening groove 11b of the post 11.

Briefly describing the assembly process of the dental implant system having such a structure, the abutment 10 is fastened and fixed to the fixture (not illustrated) implanted in the alveolar bone via the screw 13. Thereafter, a crown 20 is installed to restore the abutment 10 in a state where the sealing member 30 is in close contact with any one of the inner accommodating grooves 21 of the abutment 10 or the crown 20. Thereafter, the fixing member 40 is introduced through an entry hole 22 of the crown 20 and fastened and fixed to the abutment 10, thereby combining and fixing the crown 20 to the abutment 10.

As illustrated in FIG. 5, the grooves 11a and 12a formed in the abutment 10 and/or the grooves 21a and 21b formed in the crown 20 effectively accommodate a portion of the sealing member 30 that cannot be accommodated during the contraction process of the sealing member 30. When the sealing member 30 is positioned inside the curved accommodating grooves formed through the grooves 11a, 12a, 21a, and 21b, compared to a structure without grooves, the gap between the abutment 10 and the crown 20 is reduced and the sealing member 30 is deformed into an oval shape to absorb pressure when the pressure is applied. In addition, as the gap between the abutment 10 and the crown 20 is reduced, the sealing performance between the abutment 10 and the crown 20 may be improved.

Hereinafter, the effects of a dental implant system according to one embodiment of the present disclosure will be described.

For example, in the case of a structure in which a single groove is formed in the abutment 10 and/or crown 20, the structure may be simple, but since the extrusion of the sealing member 30 is accommodated only by one groove, the pressure distribution is limited. That is, since the accommodation capacity of the groove is limited, there is a possibility that the sealing member 30 will fall out of the groove when strong pressure is applied, and further, protrusion may occur in a specific area due to the extrusion of the sealing member 30 that is not evenly distributed.

In a case of a structure in which the plurality of grooves is formed in the abutment 10 and/or the crown 20 and the grooves are formed discontinuously and spaced apart, each groove may individually distribute pressure, thereby increasing the pressure distribution effect compared to a structure with a single groove. However, due to the spacing between the grooves, there is a possibility that a portion of the extruded sealing member 30 may protrude outside the groove, and in addition, when the sealing member 30 is subjected to strong pressure, local extrusion occurs in the area without the grooves, and it is difficult to reduce the gap between the abutment 10 and the crown 20 in the area without the grooves.

Meanwhile, in the case of the structure in which the plurality of grooves 11a, 12a, 21a, and 21b is continuously formed, as in the dental implant system according to one embodiment of the present disclosure, the extrusion of the plurality of sealing members 30 may be accommodated in various directions, so that the protrusion prevention effect is greatly improved. In addition, since each groove acts to distribute the pressure when the pressure is applied, the force applied to each groove is reduced and the stability of the sealing member is improved. In addition, since the compressed sealing member 30 is evenly distributed in the plurality of grooves, the protrusion phenomenon limited to a specific area may be minimized. In addition, since the portion recessed into the inside of the groove acts as a catch, the effect of reliably fixing the sealing member may be expected.

While preferred embodiments of the present disclosure have been described and illustrated using specific terms, such terms are solely intended to clarify the disclosure. It should be understood that various modifications and variations may be made to the embodiments and terms described herein without departing from the spirit and scope of the appended claims. Such modified embodiments should not be construed as separate from the spirit and scope of the present disclosure, but should be considered to fall within the scope of the appended claims.

What is claimed is:

1. A dental implant system in which a sealing member is installed between a crown and an abutment,
wherein a plurality of grooves is formed on each of an outer surface of a post of the abutment and an upper surface of a cuff.

2. The dental implant system according to claim 1, wherein the plurality of grooves is connected continuously.

3. The dental implant system according to claim 1, wherein the sealing member is installed to cover the plurality of grooves.

4. The dental implant system according to claim 1, wherein a plurality of grooves is formed in each of an inner accommodating groove and a lower portion of the crown.

5. The dental implant system according to claim 4, wherein the plurality of grooves formed in the crown is connected continuously.

6. The dental implant system according to claim 4, wherein the plurality of grooves formed in the crown is formed to face the plurality of grooves formed in the abutment.

7. The dental implant system according to claim 1, wherein the sealing member is formed of a laminated structure in which a plurality of circular rings, donut-shaped springs, or “C” shaped rings with one side open are laminated, or is formed in a hat shape.

8. The dental implant system according to claim 1, wherein the sealing member is formed of a cone.

9. The dental implant system according to claim 1, further comprising a fixing member for fastening and fixing the crown to the abutment.

10. The dental implant system according to claim 1, wherein the sealing member is formed of an elastic body having elasticity.

11. The dental implant system according to claim 10, wherein the elastic body is made of any one selected from a silicone material, a synthetic rubber material, a metal material in a form of an elastic fabric, or a synthetic resin material.

12. The dental implant system according to claim 1, wherein each of the plurality of grooves has a semicircular, semi-elliptical, or “V” or “U” shaped structure.
